(19) United States
(12) Patent Application Publication
(10) Pub. No.: US 2022/0063802 A1
(43) Pub. Date: Mar. 3, 2022

(54) QuadQuad: Scalable Multi Element Rotary Wing Aerial Vehicle

(71) Applicants: Narayanan Menon Komerath, Alpharetta, GA (US); Dhwanil P. Shukla, Mumbai (IN)

(72) Inventors: Narayanan Menon Komerath, Alpharetta, GA (US); Dhwanil P. Shukla, Mumbai (IN)

(21) Appl. No.: 17/460,492

(22) Filed: Aug. 30, 2021

Related U.S. Application Data
(60) Provisional application No. 63/074,057, filed on Sep. 3, 2020.

(51) Int. Cl. B64C 37/02; B64C 39/02

(52) U.S. Cl. CPC B64C 37/02; B64C 39/024; B64C 2201/126; B64C 2201/108; B64C 2201/042; B64C 2201/027

(57) ABSTRACT

An Aerial Vehicle (AV) can be used to deliver and pick up payloads. Operators of such enterprises must be ready to deliver different payloads over different ranges. Prior art would require such operators to maintain a fleet with vehicles of different sizes. Small rotary wing UAVs (RWAVs) popular in the mass market are disproportionately less expensive than large UAVs. This Scalable Multiple Element Rotary Wing Aerial Vehicle (SMERWAV) invention enables operators to meet diverse requirements with a fleet comprised of only one or two different vehicle models. Particular interest is in Rotary Wing AVs such as quadrotor UAVs. SMERWAV elements are connected to enable various missions while an operator operates only one integrated AV at a time. One embodiment SMERWAV is a “Quad-Quad” comprised of four quad-rotor AVs. Optimal configurations are selected using a method disclosed herein. SMERWAV enables low operating cost, redundancy, failure tolerance and interoperability.

### PRIOR DISCLOSURE AND FIELD

This application follows and claims domestic priority date of Provisional Patent Application No. 63/074,057, filed Sep. 3, 2020, titled “QuadQuad: Scalable Uncrewed Aerial Vehicle”. The field of the invention is Rotary Wing Aerial Vehicles.

### BACKGROUND

Aerial Vehicles can be piloted by on-board human pilot or by a remotely-located pilot, or be operated under partially autonomous or fully autonomous control. The present invention applies to all of the above types. Uncrewed Aerial Vehicles (UAVs) are suitable to deliver and pick up payloads on a retail basis, particularly in the so-called “last kilometer” of a network from centralized locations. Payloads for such retail delivery come in various sizes and weights. The range over which payloads must be delivered, varies from sub-kilometer distances to several kilometers. The requirements are diverse and require vehicles of varying payload and range capability.

In payload delivery, the majority of deliveries may be small in size and weight, and short in distance to be covered. In present practice, most deliveries can be accomplished using small UAVs. On the other hand, in order to handle larger loads and distances the operator would have to acquire and maintain expensive larger UAVs, which are only rarely used. This makes it difficult for small businesses to succeed in retail delivery using UAVs.

Due to mass-market interest in aerial photography and toys, prices of small UAVs are at very low levels relative to their advanced capabilities. On the other hand, larger UAVs have only small and specific markets and hence their cost is disproportionately high. This invention presents a method and apparatus to solve the problem presented above. With this invention, a UAV operator can operate their business using only a few inexpensive UAVs, all of them small, and still be able to deliver the occasional heavier payload or fly the longer distance as needed. The ideas in this invention can also be adapted to human-piloted and human-carrying aerial vehicles.

### PRIOR ART

Lee (1) describes a scheme for controlling several UAVs flying in formation with a suspended load. The different quadrotors fly independently and are not connected rigidly unlike the present invention. Dong (2), Srikanth (3), Agdham (5), Jones (5), Jung (6), Cichella (7) and Chirani (8) also teach operation of multiple UAVs in formation flight or cooperative tasks, where they are not physically connected and supported together, unlike in the present invention. Attention in the prior art has been focused on controlling numerous quadrotors in cooperative fashion. This approach is complex, as evidenced by the numerous technical papers on the subject. It is also not permitted by present law since one operator is only generally allowed to operate one UAV at a time. The present invention in contrast is the first to permit a single operator to operate a single vehicle with the effective payload of several UAVs, from takeoff to landing, in a legally permitted manner for civilian uses.

Quinlan (9) and Patterson (10) teach a type of fixed-wing aerial vehicle where several “child” fixed-wing UAVs take off independently of each other and then link up in flight with a “parent” UAV to form a vehicle with very large aspect ratio for efficient flight. This is taught as increasing range by increasing the aspect ratio of a fixed wing and thereby reducing the coefficient of induced drag. In Quinlan's invention, the joining of “child” fixed wing UAVs to the “parent” fixed wing UAV can occur in flight, which means that multiple vehicles must be flying at the same time, requiring multiple operators. To return to land, the joined vehicle must release “child” UAVs. This is required because it would be difficult to find runways that are wide enough to accommodate the assembled vehicle during takeoff and landing. The “child” UAVs in this case are simple components that are not useful for performing entire missions independently. Again, this illustrates the complexity in the prior art, to achieve the objective of delivering payloads over larger range. Further, Quinlan's invention does not enable carrying a payload that is heavier than the maximum takeoff payload of the “mother” UAV.

### SUMMARY OF PRESENT INVENTION

This invention makes it possible for a single operator to deliver any of a wide range of payloads in a wide range of missions, using only inexpensive, mass-market UAVs. It comprises the apparatus and method to select, optimize, assemble, prepare and operate a single integrated vehicle that is best suited for each mission. An essential feature of a modern UAV system is that each human operator is allowed to operate only one UAV at a time. To deliver a variety of payloads of different shapes, sizes and weights, an operator would need vehicles of different sizes and capabilities. This is prohibitively expensive. This invention enables an operator to deliver a wide variety of payloads with only one or two different types of vehicles.

In this invention, several Rotary Wing Aerial Vehicle elements are joined together in a prescribed manner to form a Scalable Multi-Element Rotary Wing Aerial Vehicle (SMERWAV). Although the elements can be of many kinds, and may include crewed vehicles, the initial applications of this invention are likely to include small UAVs. Specifically, the most common configuration of low-cost UAVs is the Quad-Rotor, a vehicle formed with four individual rotors, of which two rotate in a clockwise manner and two anticlockwise, placed in the same plane and generally producing thrust in the same direction. These elements are modified with a quick-connect system, with some components such as the controller de-activated, removed or otherwise modified in operation. Variable numbers of quadrotors (2, 3, 4 or more) are then connected along with a special control module and standardized connecting structural members. The result is a vehicle with the payload and range capabilities of a large Aerial Vehicle having several times the capabilities of a single small element. An operator uses the method described here to determine the optimal combination of components, selects them from inventory and quickly assembles the vehicle needed for a given mission. Following the mission, the component parts can be disassembled and reconfigured for a different mission. The assembled vehicle offers a greater payload capability than the sum of payloads of individual vehicles. Range is also increased beyond the range of any one vehicle. Range and speed are increased by adding one or more fixed wings above the assembled set of rotary wing vehicles, and setting them at suitable geometric attitudes to generate aerodynamic lift while achieving a high lift to drag ratio. Said assembled vehicle permits said wings to be of larger planform area and aspect ratio, and operate at larger Reynolds Number than wings that can be used with individual small rotary wing vehicles. As a result, large gains in range and speed are possible when wings are combined with said assembled vehicle, compared with what is possible with individual vehicles. Said wings can also be of a modular nature, as shown by Quinlan.

### Advantages of Present Invention

The present invention is an improvement in the state of the art because of its simplicity and the large reduction in cost that it enables. This invention allows operators to achieve small-UAV costs while offering large-UAV capability. The operator has to acquire only one or two different types of small UAVs plus an embodiment of this invention.

### LIST OF DRAWINGS

FIG. 1: One embodiment of a quad-quad rotor configuration.

FIG. 2: Another embodiment of a quad-quad rotor configuration with a central frame.

FIG. 3: Vehicle with 3 quadrotors.

FIG. 4: Vehicle with 5 quadrotors.

FIG. 5: Multi-quadrotor with wing added.

FIG. 6: Multi-quadrotor with two wings added.

FIG. 7: Control scheme where all rotors of same sense are connected.

FIG. 8: Control scheme where an identical set of motor control signals is sent to all peripheral UAVs from the central controller.

FIG. 9: Control scheme where each peripheral UAV is actuated as a single rotor.

FIG. 10: Control scheme where each peripheral UAV is actuated like two sets of two rotors.

FIG. 11: Artistic conception of one embodiment, showing a quad-quadrotor vehicle assembly with tethered slung payload.

### BRIEF DESCRIPTION OF THE DRAWINGS

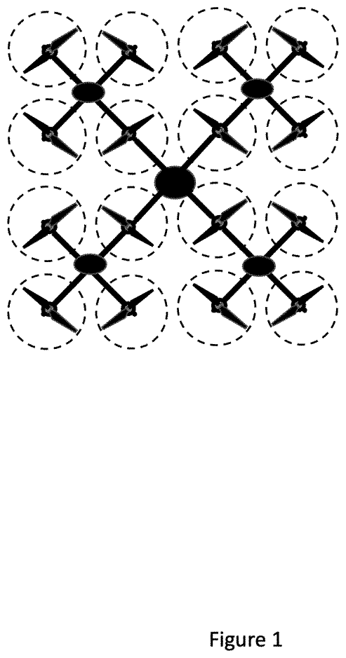

FIG. 1 shows the basic idea of a multiple-quadrotor vehicle. Several UAVs are joined together to form a single vehicle. In this case, four quadrotor UAVs are formed into a single quad-quad rotor vehicle, with 16 rotors. In the embodiment shown, the diagonal supports that hold the motors are joined together by extension elements.

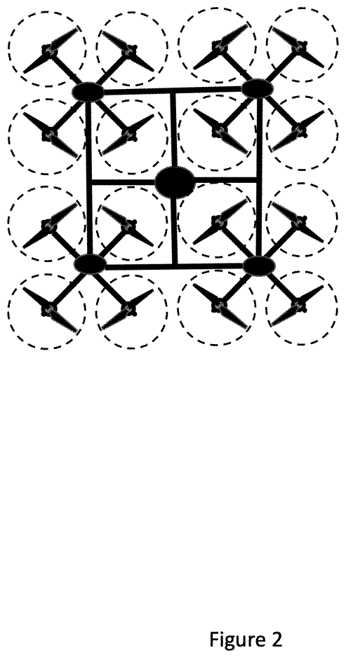

FIG. 2 shows another of many ways in which quadrotors may be combined into a large vehicle using the present invention. In the embodiment shown, a square frame connects the centers of the 4 quadrotors.

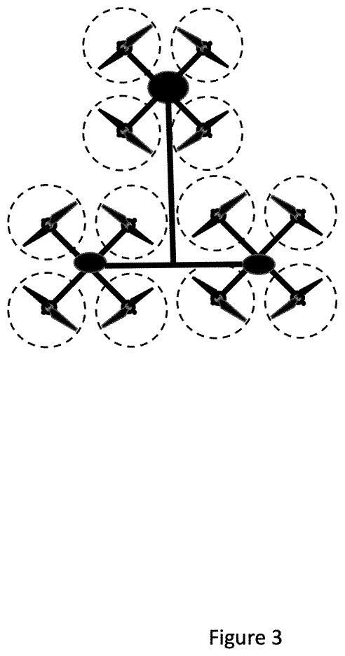

FIG. 3 shows an implementation of a large vehicle combining three quadrotors. In this embodiment, structural elements are combined in a T-shape.

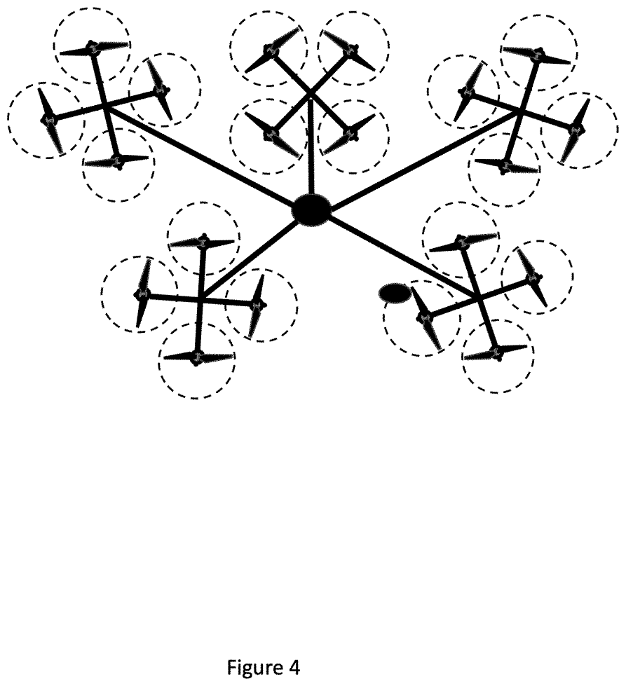

FIG. 4 shows a vehicle with 5 quadrotors combined. Here the connecting elements are configured in a radial manner. This is easily modified into a vehicle connecting 6, 8 or more quadrotors in a radial distribution.

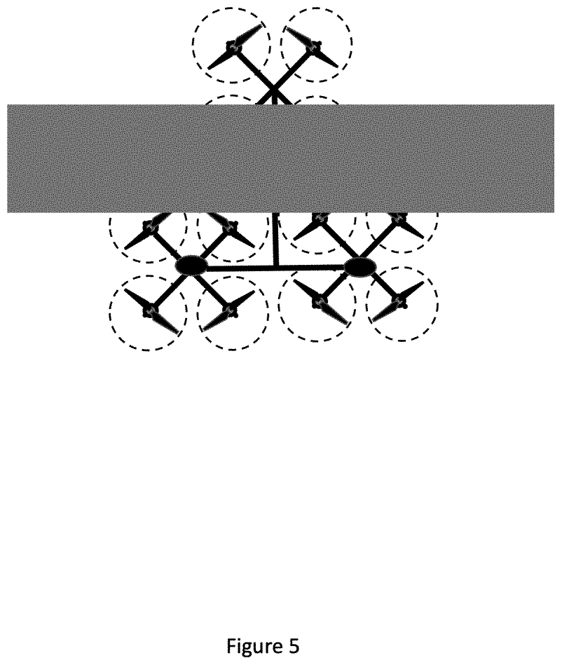

FIG. 5 shows a vehicle with 3 quadrotors combined with a wing. The wing is held on a light frame that is fixed to the frame holding the quadrotors together.

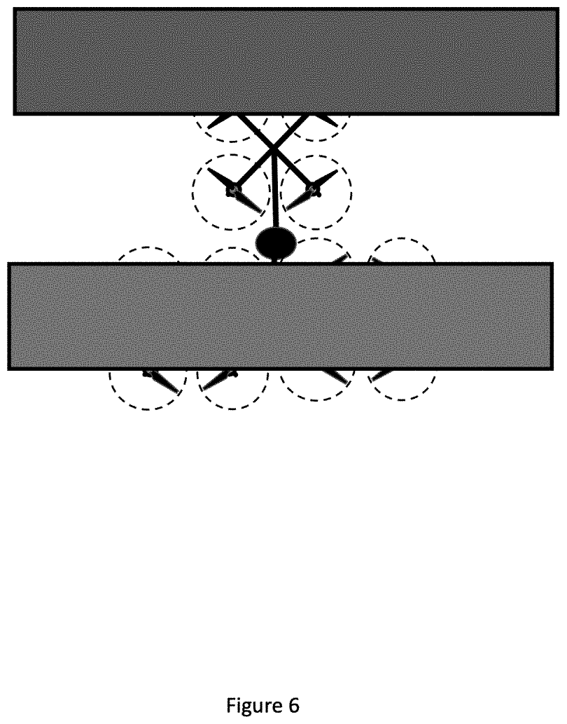

FIG. 6 shows a vehicle with 3 quadrotors combined with 2 wings. Two wings are held on the frame that is fixed to the frame holding the quadrotors together. The wings are spaced longitudinally in a manner designed to assure static stability of the entire vehicle. The front wing is positioned lower than the rear wing.

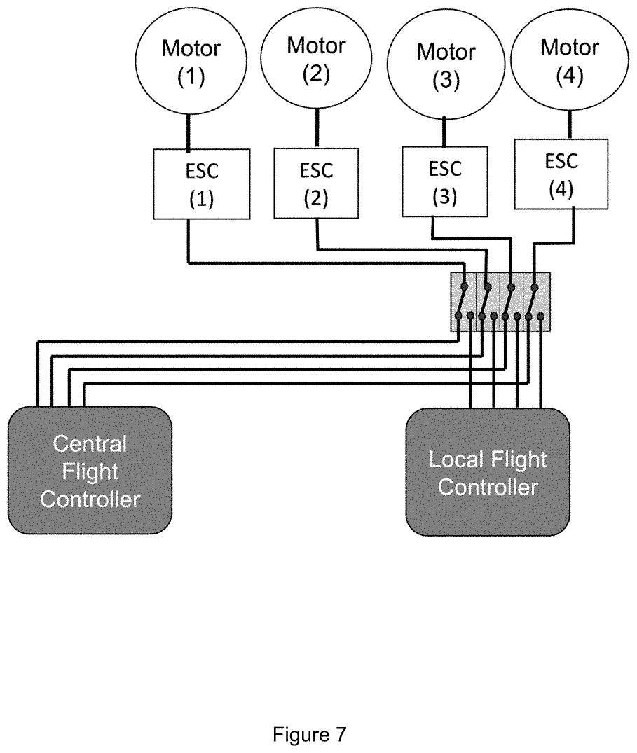

FIG. 7 shows one embodiment of a control scheme for multi-UAV vehicles, where all rotors of the same sense (for instance, left front rotor) are connected together. This scheme enables rapid connection without modifying control software significantly.

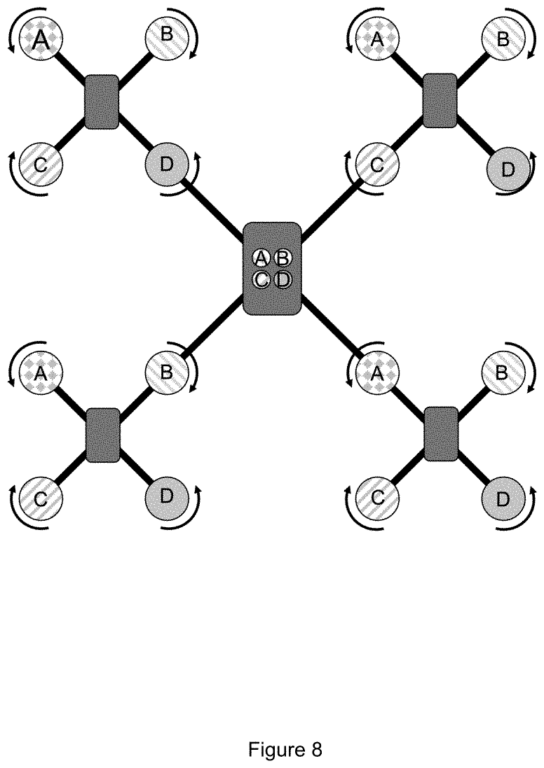

FIG. 8 shows an embodiment where identical set of motor control signals sent to all peripheral UAVs from the central controller. Peripheral UAV flight controllers are disengaged. The advantages of this embodiment are that it retains all controls, supports all kinds of configurations, and the operator does not need to think which UAV goes where while assembling and wiring.

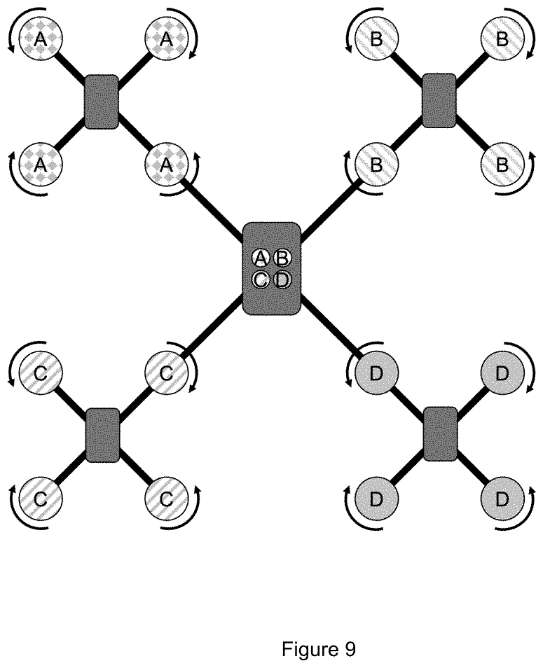

FIG. 9 shows an embodiment where each peripheral UAV is actuated like a single rotor. Advantages include high angular accelerations for control, and only one signal motor control signal has to be sent per UAV from a central controller.

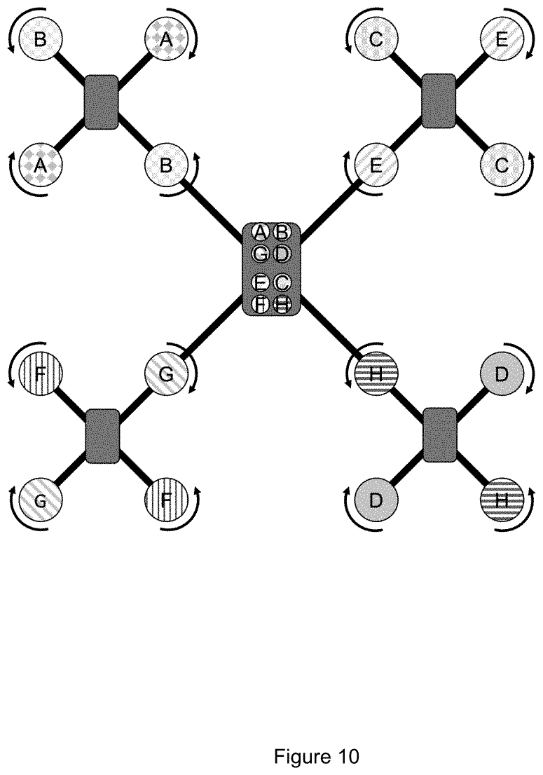

FIG. 10 shows an embodiment where each peripheral UAV is actuated like two sets of two rotors. One set rotating counter-clockwise, and the other rotating clockwise. Advantages include high angular accelerations for control, and the possibility of yaw control.

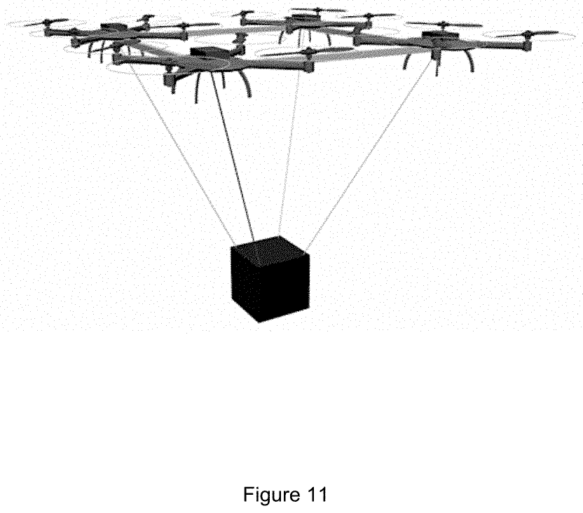

FIG. 11 shows an artistic depiction of one embodiment of the invention where four quadrotor UAVs are assembled into a single vehicle, with a tethered slung payload.

### DETAILED DESCRIPTION

An essential feature of a modern UAV system is that each human operator is allowed to operate only one UAV at a time. Thus all the different vehicles must be physically joined together, and flown with a single controller. This controller is hereinafter known as the Central Controller (CC), regardless of physical location of said controller in the geometry of the assembled vehicle. Assembled vehicle is known as cluster hereinafter. In one embodiment, said CC can be a separate component which is attached to the frame that is used to connect the different vehicles. In another embodiment, CC may be the unit that is present on one of the AVs that is designated as the central AV. Said CC can control the whole connected cluster of vehicles. Other peripheral AV controllers can be bypassed using a switch on each of them. The switch will allow said peripheral AV motors to accept commands from CC instead of the particular local controller that is associated with each of said peripheral AV motors when in cluster mode. Said local controllers do not have to be removed physically. All changes are performed using software, already installed and programmed into each controller.

Said CC sends only motor speed signals to said peripheral AVs through the connectors built into the structural tubes. All peripheral AVs receive generally same set of motor speed signals from CC. As an example, the term speed signals refers to the speed signal for each of the front right, front left, rear right, and rear left motors. Electrical power required to operate each motor is still generally obtained from batteries that operate said motors when they are used as individual vehicles. While adding peripheral AVs to a cluster, only the Proportional-Integral-Derivative (PID) gain values of the CC may have to be adjusted.

Concerns include the following: (a) Wiring during assembly must be done very carefully, (b) some restrictions must be placed on possible UAV configurations, (c) more bending moments and stresses are expected on the structural elements, and (d) a more complex controller is needed as the main controller. A quadrotor controller for coaxial rotors will work for this embodiment. To address the wiring concerns, particular integrated harnesses are prepared in this invention.

### Connection and Operation

Any AV can be used as the central AV. No special qualifications are needed. An argument can be made on why multiple AVs can work in sync using a single controller and be able to retain all the degrees of freedom and control motions. The GPS (Global Positioning System) and gimbals on the individual AVs must be bypassed. Only motor signals are replaced. The peripheral controllers are switched off. The bypass switch can be a simple toggle switch (or a set of 5 switches combined) available in the electronics market. Only the wiring has to be done appropriately.

One embodiment of the commands to each AV, shown in FIG. 7, is as follows. The front left rotors of all the attached AVs will get actuated simultaneously, and analogously for the other three rotors. This generates pitching, rolling, and yawing moments on each AV individually. The resultant moment on the cluster will be the sum of all these moments, and the cluster will retain all control. Now as each AV is doing the exact same thing, the same set of signals is sent to all. Therefore there is no need for rewiring. One disadvantage of this arrangement is that the forces causing pitching, yawing and rolling moments are distributed over the vehicle and may be less effective, with shorter moment arms from the center of gravity.

In another embodiment, all rotors of each quadrotor can be wired to operate together with only their rpms varied together. In this embodiment each quadrotor element serves essentially as one rotor. This maximizes the said moment arms. However it has a disadvantage in that yawing moment is not derived from the different torques experienced by rotors of different senses of rotation.

Yet another embodiment could overcome said disadvantage in yawing moment, by separating the rotors of each vehicle element by sense of rotation. Both of the last two embodiments described above, require some re-wiring. In a full implementation, quadrotor vehicles would be wired with connectors to accommodate such changes, while specially programmed controllers would be designated as Central Controllers, and form part of a modification kit to connect several quadrotors into a single vehicle. In some embodiments sensors may be located at each of the corners. This will enable finer control.

### Controlling Vibrations

An added feature of present invention is that a few (1 to 3) acceleration sensors are placed at strategic locations on the vehicle frame. These can be either permanent fixtures embedded in modular structure components, or added-on specifically. Software in the controller module is configured to use acceleration data from these sensors to perform a System Identification procedure, and capture modes of vibration occurring on the structure. These include aerodynamically induced instabilities and deformations of the structure itself. The controller then adjusts the thrust to different rotors to cancel out as much as possible, these vibrations or vehicle instabilities. Structural and aerodynamic vibrations are alleviated or cancelled by controlling thrust of specific rotors.

### Winged Operation

As shown in FIGS. 5 and 6, fixed wings may be added to SMERWAV. As speed increases, wing lift increases, so that the vehicle can pitch forward further, causing the rotor thrust to be directed more in the flight direction and further accelerate the vehicle. As the wings enter the regime of best lift to drag ratio, the thrust required to maintain a desired speed decreases, so that the rotor power can be scaled back. When the SMERWAV size is increased by adding more elements, the span of each wing can be increased by attaching more wing elements, thus increasing the aerodynamic lifting surface area, as well as the span. As a result the flight speed and the lift to drag ratio increase, beyond the scaling of the lift.

### Range Optimization by Shutting Off Some Rotors

Yet another optional feature of the present invention is that of increasing range and payload by the ability to shut off or reduce thrust to specific rotors when they are not needed. The optimal values of thrust to each rotor are calculated by software in the controller module. On the outbound portion of the mission, all the component vehicles are required to produce the required thrust and control. Once the payload is delivered, less thrust suffices. This reduced thrust may be accomplished by either reducing thrust to all rotors appropriately, or by only shutting off or reducing thrust to specific rotors. Some AV batteries and some AV fuel-burning engines, operate less efficiently at lower thrust settings. In these cases it is more fuel-efficient to operate some rotors at full thrust, while shutting off as many other rotors as possible. Software is included in the controller module to perform the necessary computations and control.

### Method of Selecting Optimal Configuration

Various permutations and combinations of vehicles of each type, are performed by the designer, vendor and/or operator of said SMERWAV system. As discussed in the Background section of this specification document, one application of the apparatus described above, is in retail delivery enterprises. An embodiment of the method of selecting optimal configuration for each delivery mission is discussed below in the context of such retail delivery application. At the end of this discussion it is shown how to generalize said method to other related applications.

Existing procedures of rotorcraft aeromechanics are used to calculate performance of various configurations involving RAVs that are available to the operator. Said procedures are obtained by obvious extensions of textbook processes relevant to the stated field of this invention, Rotary Wing Aerial Vehicles. Once the performance of each configuration is obtained, charts and tables are prepared, summarizing said performance. Such charts and tables will be of a form that makes their interpretation obvious to operators who have received adequate training and qualification in operating small uncrewed aerial systems (sUAS). Typically, for each class of RAV, a chart and table is made available. Said chart shows range on one axis and payload to be carried over said range on the other. Numbers marked on said chart refer to configuration descriptions that are provided in associated table. Other associated tables and diagrams for each configuration specify the procedures to be followed to perform necessary connections, software installations and testing procedures before using said configuration in flight. Each operator determines the range and payload for each mission, and uses said charts and tables to determine best configuration. Further, from associated diagrams and tables, necessary components are selected, assembled and tested prior to use.

The above method removes the necessity for operators to perform calculations or study theoretical methods to predict the performance of a given configuration. Operators of normally expected qualifications and training will be able to select the best configuration, prepare and test said configuration, and operate it safely and effectively for a selected mission.

It is obvious that the method described above is equally applicable to other missions than retail delivery. It is applicable to carrying camera and/or other sensor payloads for photography, videography, or other sensing missions. Said method may also be applied to law enforcement or related missions.

### REFERENCES

(1) Lee, T., Sreenath, K. and Kumar, V., “Geometric Conrol of Cooperating Multiple Quadrotors With a Suspended Payload. Geometric control of cooperating multiple quadrotor UAVs with a suspended payload. In 52nd IEEE conference on decision and control (pp. 5510-5515). IEEE, December 2013.
(2) Dong, X., Zhou, Y., Ren, Z., & Zhong, Y. (2016). Time-varying formation tracking for second-order multi-agent systems subjected to switching topologies with application to quadrotor formation flying. IEEE Transactions on Industrial Electronics, 64(6), 5014-5024.
(3) Srikanth, M., Soto, A., Annaswamy, A., Lavretsky, E., & Slotine, J. J. (2011, August). Controlled manipulation with multiple quadrotors. In AIAA Guidance, Navigation, and Control Conference (p. 6547).
(4) Aghdam, A. S., Menhaj, M. B., Barazandeh, F., & Abdollahi, F. (2016, January). Cooperative load transport with movable load center of mass using multiple quadrotor UAVs. In 2016 4th International Conference on Control, Instrumentation, and Automation (ICCIA) (pp. 23-27). IEEE.
(5) Jones, L. (2012). Coordination and control for multi-quadrotor UAV missions. NAVAL POSTGRADUATE SCHOOL MONTEREY Calif.
(6) Jung, S., & Ariyur, K. B. (2017). Strategic cattle roundup using multiple quadrotor UAVs. Int. J. Aeronaut. Space Sci, 18, 315-326.
(7) Cichella, V., Kaminer, I., Xargay, E., Dobrokhodov, V., Hovakimyan, N., Aguiar, A. P., & Pascoal, A. M. (2012, December). A Lyapunov-based approach for time-coordinated 3D path-following of multiple quadrotors. In 2012 IEEE 51st IEEE Conference on Decision and Control (CDC) (pp. 1776-1781). IEEE.
(8) Shirani, B., Najafi, M., & Izadi, I. (2019). Cooperative load transportation using
(9) Quinlan, J. R., “System and Method For Modular Unmanned Aerial System”. US Patent 10,196,143 B2, Feb. 5, 2019.
(10) Patterson, M. D., Quinlan, J. R., Fredericks, W. J., “Modular Unmanned Aerial System With Multi-Mode Propulsion”. U.S. Pat. No. 10,189,565, Jan. 29, 2019.

What is claimed is:

1. Scalable Multi-Element Rotary Wing Aerial Vehicle (SMERWAV), which can be adapted to different missions by attaching or removing components; said SMERWAV comprising:
a plurality of Rotary Wing AVs (RWAVs), with components removed or added;
connectors and cables to interconnect said plurality of RWAVs in a desired manner; and
one or more wings that are affixed to said SMERWAV.

2. Method to determine optimal configuration of vehicle comprising a set of interlinked RWAV appropriate for each mission, consisting of:
calculating performance of said vehicle in each of various configurations for each of various missions;
preparing a display of configurations comprising a chart, a table, or both;
preparing mission descriptions comprising a chart, a table, or both;
preparing instructions to prepare said vehicle for each mission; and
referring to said chart and/or table, and said instructions.

3. Method of implementing redundancy measures to operate the SMERWAV of claim 1 in cases of component failure.

4. SMERWAV of claim 1 wherein area of said wings is adjusted by elastic sheet means.

5. Method of assembling and disassembling SMERWAV of claim 1 to achieve desired range, speed and payload by attaching or removing components, said method consisting of:
connecting structural elements and fasteners;
attaching or removing multiple SMERWAV components of a similar nature;
providing or removing one or more control systems;
attaching or removing one or more wings;
connecting or disconnecting one or more batteries; and
attaching a payload suitable for selected mission by external or internal means.

6. Method of using an odd number of rotors in a SMERWAV of claim 1 by means of coaxial rotor system.

7. Method of claim 1 where said SMERWAV comprises connecting quadrotor AVs with a single controller, where
all rotors of like designation are connected together;
all rotors in each quadrotor are connected together; and
all rotors of similar sense of rotation in each quadrotor are connected together.

8. Method of cancelling structural and aerodynamic vibrations of said SMERWAV of claim 1 by controlling thrust of specific rotors.

9. SMERWAV of claim 1 where range is improved by reducing power to specific rotors.

10. Method of claim 2 where:
integrated cable harnesses are prepared, said harnesses comprising cables with pre-wired connectors suited for each configuration; and
enabling swift connection of different combinations of rotors.
